(19) United States
(12) Patent Application Publication
(10) Pub. No.: US 2010/0201508 A1
(43) Pub. Date: Aug. 12, 2010

(54) CROSS TRAFFIC ALERT SYSTEM FOR A VEHICLE, AND RELATED ALERT DISPLAY METHOD

(75) Inventors: CHARLES A. GREEN, CANTON, MI (US); UZMAA H. BALBALE, CANTON, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/370,239

(22) Filed: Feb. 12, 2009

(51) Int. Cl. B60Q 1/00

(52) U.S. Cl. 340/435

(57) ABSTRACT

A rear cross traffic alert system for a vehicle is utilized to generate and display rear cross traffic warning symbols to the driver during reverse gear maneuvers. The system includes a sensing subsystem configured to monitor for cross traffic behind the vehicle, a processor architecture, and a rear vision display element. The processor architecture is configured to receive sensor data from the sensing subsystem and, when the sensor data indicates a warning condition caused by an object detected by the sensing subsystem, generate image rendering display commands associated with a cross traffic warning symbol. The rear vision display element is configured to receive the image rendering display commands and, in response thereto, render the cross traffic warning symbol in a manner that visually indicates presence of the object.

### TECHNICAL FIELD

Embodiments of the subject matter described herein relate generally to vehicle safety systems. More particularly, embodiments of the subject matter relate to a rear cross traffic alert system.

### BACKGROUND

The prior art is replete with onboard vehicle systems that are intended to enhance safety and increase the situational awareness of the driver during various maneuvers. For example, many vehicles are now outfitted with rear vision display systems. A typical rear vision display system includes a dashboard or console mounted video display, which displays a video image feed taken from a camera located at the rear of the vehicle. The video image provides a rearward field of view to the driver that might otherwise be obscured, resulting in enhanced safety before and during back-up maneuvers.

As another example, many vehicles include rear parking assist systems. A typical rear parking assist system utilizes one or more obstacle-detecting sensors mounted at the rear of the vehicle. When the vehicle is in reverse gear, the rear parking assist system will generate alerts (e.g., beeping noises and/or lights) when the sensors detect an obstacle in the rearward path of the vehicle. The alerts can vary in frequency, volume, pattern, etc., in accordance with the detected distance between the rear of the vehicle and the obstacle. The alerts may notify the driver prior to a collision with the detected obstruction.

Some vehicles may also include a rear cross traffic alert (“RCTA”) system. An RCTA system enhances situational awareness by providing an alert when it detects oncoming cross traffic behind the vehicle, where such cross traffic represents a potential hazard when the vehicle is backing up. The RCTA system could also be used to assist the driver in other situations, such as parallel parking. FIG. 1 is a diagram that depicts a typical RCTA system in use. In FIG. 1, the host vehicle 100 includes an onboard RCTA system. FIG. 1 depicts a scenario where host vehicle 100 is backing out of a parking spot 102 that is surrounded by a number of parked vehicles 104. Another vehicle 106 is approaching parking spot 102 as it moves down the parking aisle. The RCTA system is designed to detect approaching cross traffic (such as vehicle 106) in advance of a potential collision with host vehicle 102. A typical RCTA system may detect the presence of approaching vehicles using one or more sensors 108 located at or near the rear of host vehicle 100. Depending upon the surroundings and driving conditions, the approaching vehicle 106 may not be visible through the windows of host vehicle 100. Moreover, the approaching vehicle 106 may not be within the field of view of a rear vision camera. Even under such conditions, the RCTA system may detect the approaching vehicle 106 (using the sensors 108) and generate an alert to the driver of host vehicle 100.

### BRIEF SUMMARY

A method for displaying rear cross traffic alert information on a rear vision display element of a vehicle is provided. The method involves: obtaining sensor data from a rear cross traffic detection system; determining when the sensor data indicates a potential cross traffic collision between the vehicle and a detected object; and, in response to the determining step, displaying a cross traffic warning symbol on the rear vision display element. The cross traffic warning symbol visually indicates the presence of the detected object.

A rear cross traffic alert system for a vehicle is also provided. The system includes a sensing subsystem configured to monitor for cross traffic behind the vehicle. The system also includes a processor architecture that receives sensor data from the sensing subsystem and, when the sensor data indicates a warning condition caused by an object detected by the sensing subsystem, generates image rendering display commands associated with a cross traffic warning symbol. The system also includes a rear vision display element configured to receive the image rendering display commands and, in response thereto, render the cross traffic warning symbol in a manner that visually indicates presence of the object.

A rear vision display element for a vehicle is also provided. The rear vision display element is used to render a rear display having a real-time rearward image corresponding to a rearward view from the vehicle, and having a cross traffic warning symbol superimposed on the real-time rearward image. The cross traffic warning symbol visually indicates the presence of an object behind and to the side of the vehicle.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram that depicts a typical RCTA system in use;

FIG. 2 is a schematic representation of an exemplary embodiment of an onboard RCTA system for a vehicle;

FIG. 3 is a schematic representation of an exemplary rear vision display element having rendered thereon a cross traffic warning symbol;

FIG. 4 is an elevation view of a portion of a host vehicle having deployed therein an exemplary embodiment of an RCTA system; and

FIG. 5 is a flow chart that illustrates an exemplary embodiment of a rear cross traffic alert display process.

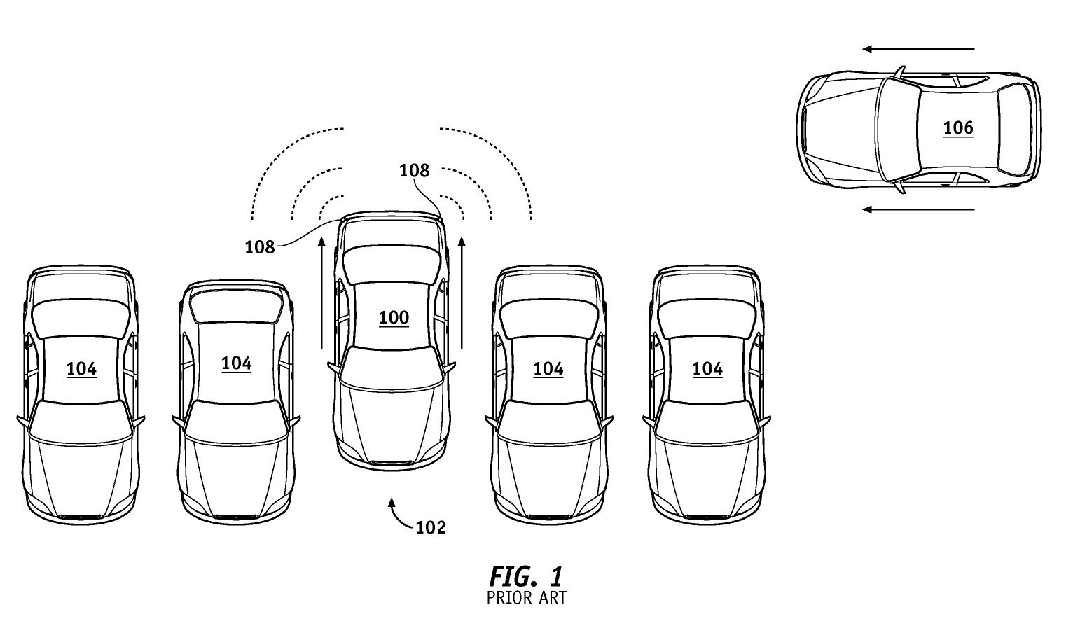

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

For the sake of brevity, conventional techniques related to vehicle-based image capturing and image processing, object detection and sensing, graphics rendering, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The techniques and technology described herein relate to an onboard RCTA system for a vehicle. An RCTA system configured as described herein leverages a rear vision display element, and the RCTA system generates and renders graphical rear cross traffic alert symbols on the rear vision display element. In this manner, the RCTA system displays alert symbols in an intuitive and user-friendly location where the driver may already be looking while backing up. Leveraging the rear vision display element in this manner results in component reuse and reduces manufacturing and deployment costs associated with the RCTA system.

In operation, triggering of a rear cross traffic alert results in the presentation of a visual warning symbol on the same display element that is used for the rear vision system. The rear cross traffic alert symbol is rendered in an appropriate location on the rear vision display (e.g., to the left or right side) that indicates the position or approaching path of the detected object. The alert symbol might be chosen such that it graphically indicates a hazard, a vehicle, or a potential collision, and the alert symbol might visually indicate or otherwise be rendered in a manner that indicates the distance between the host vehicle and the approaching vehicle. The alert symbol may have distinctive, variable, or distinguishable visual characteristics that convey the nature of the threat—the visual characteristics may also be rendered with the goal of capturing the driver's attention. Moreover, if combined with a rear vision display having an expansive field of view, the location of the alert symbol on the rear vision display could track the approaching object or indicate the distance to the approaching object in real-time.

Integration of the rear cross traffic alert into a rear vision display image can increase situational awareness of the driver, and can reinforce that the potential threat is located to the rear of the vehicle. Placement of the rear cross traffic alert symbol within the rear vision image can provide directional and/or distance information in a readily absorbed and understood manner. Thus, the driver will be more likely to notice such an alert as it is presented on a display element where he or she may already be looking at the time of the maneuver (e.g., backing up).

Although the following description refers to “cross traffic” that can be detected, the RCTA system can of course sense and detect the presence of other objects, obstacles, or obstructions proximate the host vehicle. For example, the RCTA system could be configured and calibrated to detect the presence of pedestrians, animals, bicycles, and other objects in addition to vehicles, whether moving or stationary.

In addition, although the following description refers to rear cross traffic detection, the concepts, techniques, and technologies can be equivalently deployed in an onboard system that detects front cross traffic. Of course, a front cross traffic detection system would be suitably configured to detect approaching vehicles or objects that are in front of and to the side of the host vehicle (rather than vehicles or objects that are behind and to the side of the host vehicle). Those skilled in the art should understand how to modify the rear cross traffic detection system described herein for use as a front cross traffic detection system.

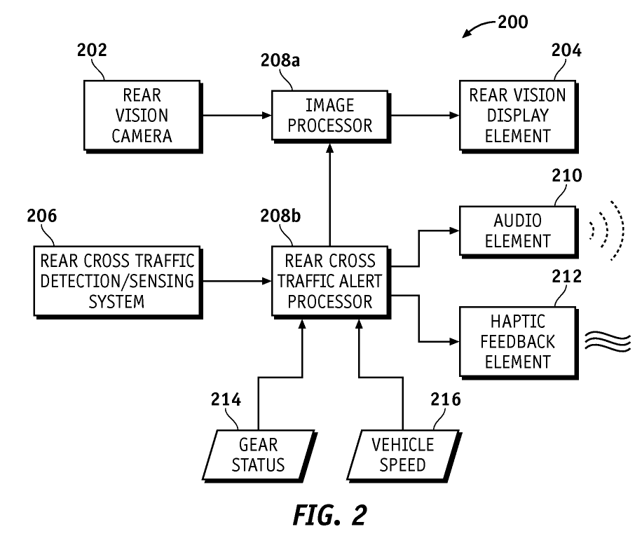

The RCTA system described here is preferably implemented as an onboard vehicle system. In this regard, FIG. 2 is a schematic representation of an exemplary embodiment of an onboard RCTA system 200 for a vehicle. This embodiment of RCTA system 200 includes, without limitation: a rear vision camera 202; a rear vision display element 204; a detection/sensing system (or subsystem) 206; and a processor architecture 208. Certain embodiments of RCTA system 200 may also include an audio element 210 and/or a haptic feedback element 212. The elements and components of RCTA system 200 can be coupled together as necessary (using any suitable bus, interconnect, interface, network, and/or other topology) to support the functionality of RCTA system 200. A practical implementation of RCTA system 200 might include additional elements, circuits, and/or logical components that are configured to support conventional functions or features that are unimportant to the primary RCTA functions.

Processor architecture 208 can be implemented and realized using one or more processor components, which may be co-located or distributed throughout the host vehicle. A given processor component may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

Processor architecture 208 is suitably configured to receive and process data from various onboard sources, determine when a potential collision or warning condition exists, and generate appropriate image rendering display commands associated with cross traffic warning or alert symbols (as needed). The processor architecture 208 depicted in FIG. 2 includes two processor components, devices, or logical partitions: an image processor 208a and a rear cross traffic alert processor 208b. In preferred embodiments, image processor 208a and rear vision display element 204 can be packaged together as a single component or hardware module. Similarly, in preferred embodiments, rear cross traffic alert processor 208b and rear cross traffic detection/sensing system 206 can be packaged together as a single component or hardware module. Image processor 208a is responsible for generating image rendering display commands that in turn can be interpreted and acted upon by rear vision display element 204. Thus, rear vision display element 204 responds to received image rendering display commands and renders an appropriate image (or images) corresponding to the received image rendering display commands. Rear cross traffic alert processor 208b is primarily responsible for obtaining sensor and/or status data for the vehicle, processing the received information, and determining whether a rear cross traffic alert or warning needs to be generated. As depicted in FIG. 2, rear cross traffic alert processor 208b may communicate with image processor 208a as needed so that image processor 208a can generate image rendering display commands associated with cross traffic warning symbols having the display characteristics described below.

Rear vision camera 202 is suitably configured to capture a real-time rearward image that corresponds to a rearward view from the host vehicle. In preferred embodiments, rear vision camera 202 can capture images in a continuous or virtually continuous manner such that RCTA system 200 can render a real-time video feed on rear vision display element 204. Rear vision camera 202 can be located at or near the rear of the host vehicle. For example, rear vision camera 202 may be mounted or integrated into the rear bumper, the rear window assembly, the rear roof structure, or the license plate area of the host vehicle. Image data from rear vision camera 202 can be provided to image processor 208a. In turn, image processor 208a prepares image rendering display commands that are associated with the real-time rearward images. Accordingly, rear vision display element 204 can render the rear vision images (along with superimposed rear cross traffic alert symbols when applicable) in response to the image rendering display commands.

Rear vision display element 204 may be used to display various images and data, in both a graphical and a textual format, and to supply visual feedback to the user. Rear vision display element 204 may be realized using any suitable display technology, such as, without limitation: LCD; OLED; TFT; HUD projection; or any known technology. The specific location, shape, and size of rear vision display element 204 may be selected to accommodate the structural configuration of the host vehicle, user preferences, ergonomic considerations, or the like. For example, rear vision display element 204 might be integrated into or located at: a rearview mirror of the vehicle, a side mirror of the vehicle, a video game unit of the vehicle, an audio/visual entertainment unit of the vehicle, a head-up display of the vehicle, a navigation unit of the vehicle, a dashboard display unit of the vehicle, a visor of the vehicle, a passenger cabin pillar of the vehicle, and/or other locations that are visible to the driver.

Rear cross traffic detection/sensing system 206 is suitably configured to monitor for the presence of cross traffic, obstructions, moving objects, people, etc., which might be located behind and to the sides of the host vehicle. In certain embodiments, rear cross traffic detection/sensing system 206 includes one or more sensors located at or near the rear of the host vehicle. In preferred embodiments, rear cross traffic detection/sensing system 206 includes at least two sensors—one located at or near the left and right rear corners of the host vehicle. These sensor locations allow RCTA system 200 to detect cross traffic approaching from either side of the host vehicle, and the sensors are preferably configured to provide a wide angle detection range. The sensors used by rear cross traffic detection/sensing system 206 may be realized using any appropriate sensor technology. For example, these sensors may be implemented with radar sensors, optical sensors, infrared sensors, sonar sensors, ultrasonic sensors, or the like. During operation, these sensors provide sensor data to rear cross traffic alert processor 208b, where such sensor data conveys or otherwise indicates the presence of an object, the relative direction of the object, and/or the distance to the object. In a basic embodiment, the sensor data may represent a trigger signal that indicates whether or not an object has been detected. In other embodiments, the sensor data could include real-time distance information along with angular information, relative velocity information, etc.

Rear cross traffic alert processor 208b processes the received sensor data (possibly with other data obtained from various onboard sources) to determine whether or not to issue a rear cross traffic warning. For the preferred embodiment described here, rear cross traffic alert processor 208b processes gear status data 214 and vehicle speed data 216 along with the sensor data received from rear cross traffic detection/sensing system 206. Certain embodiments may also be suitably configured to process steering wheel angle and/or yaw angle data to determine the host vehicle path and whether or not the host vehicle path might intersect the path of the approaching object. Gear status data 214 may be provided by an appropriate onboard control module or processing component, such as an engine control module or a transmission control module (not shown). Similarly, vehicle speed data 216 may be provided by an appropriate onboard control module or processing component, such as a brake controller or processor or a traction control module (not shown).

In the context of RCTA system 200, gear status data 214 conveys or indicates whether the host vehicle is currently in a gear that triggers the rear vision image and the rear cross traffic detection/sensing system 206. For example, the rear vision image and rear cross traffic detection/sensing system 206 might be triggered only when the host vehicle is in reverse. Alternatively, they might be triggered when the host vehicle is in reverse or neutral. In other embodiments, they might be triggered when the host vehicle is in any non-forward driving gear.

In the context of RCTA system 200, vehicle speed data 216 conveys or indicates the current speed of the host vehicle (in preferred embodiments, this will be the speed while the host vehicle is in reverse). Rear cross traffic alert processor 208b processes vehicle speed data 216 (in conjunction with the sensor data received from rear cross traffic detection/sensing system 206) to determine whether the current conditions represent an immediate collision risk or potential hazard. For example, if vehicle speed data 216 indicates that the host vehicle is not moving, then it may not be necessary for rear cross traffic alert processor 208b to issue a cross traffic warning. On the other hand, if vehicle speed data 216 indicates that the host vehicle is backing up at a relatively high velocity, then rear cross traffic alert processor 208b will issue a cross traffic warning if it predicts a collision with an oncoming vehicle.

Audio element 210 is suitably configured to generate an audible alert in some embodiments when the sensor data from rear cross traffic detection/sensing system 206 indicates a warning condition associated with detected rear cross traffic. In this regard, audio element 210 may be a speaker or other transducer that generates a distinguishable sound or noise (e.g., a beep or a beeping pattern) in response to the detection of rear cross traffic. Such audible feedback is preferably generated in concert with the display of an appropriate alert symbol on rear vision display element 204.

Haptic feedback element 212 is suitably configured to generate a haptic feedback alert when the sensor data from rear cross traffic detection/sensing system 206 indicates a warning condition associated with detected rear cross traffic. In this regard, haptic feedback element 212 may be a vibration or impact-generating component that is actuated in response to the detection of rear cross traffic. When actuated, haptic feedback element 212 transmits haptic feedback to the driver that indicates the presence of rear cross traffic and, in preferred embodiments, the approaching direction of the cross traffic. For example, if the host vehicle is outfitted with a haptic driver seat, then the left side or left rear corner of the seat will vibrate if RCTA system 200 detects rear cross traffic approaching from the driver side of the host vehicle, and the right side or right rear corner of the seat will vibrate if RCTA system 200 detects rear cross traffic approaching from the passenger side of the host vehicle. Notably, such haptic feedback is preferably generated in concert with the display of an appropriate alert symbol on rear vision display element 204.

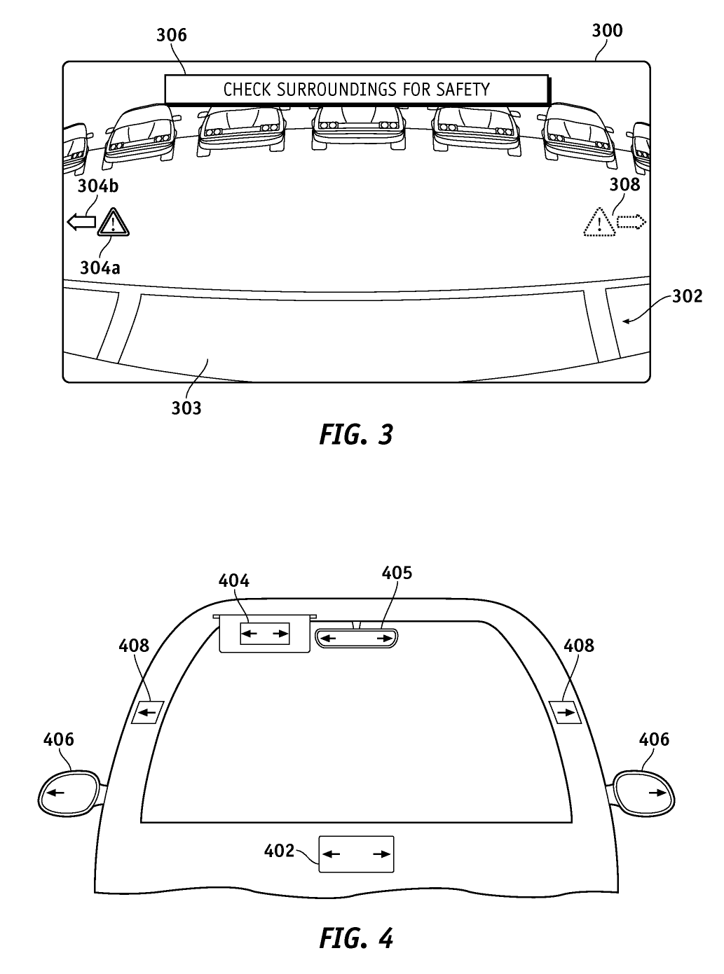

FIG. 3 is a schematic representation of an exemplary rear vision display element 300 having rendered thereon a rear display 302. Rear display 302 may include, without limitation: a real-time rearward image 303; a cross traffic warning symbol 304 superimposed on real-time rearward image 303; and an alphanumeric field 306 that conveys a warning message. As explained above, real-time rearward image 303 corresponds to the current rearward view from a vantage point on or near the rear of the vehicle. Moreover, rearward image 303 is rendered as a mirror image to the driver—rearward image 303 is akin to an image as viewed using the rearview mirror of the vehicle. Notably, cross traffic warning symbol 304 is intended to visually indicate the presence of an object behind and to the side of the host vehicle.

Cross traffic warning symbol 304 may include any number of separate graphical elements. The version depicted in FIG. 3 includes two graphical elements: a warning triangle 304a, and a directional arrow 304b. Warning triangle 304a visually indicates an alert, hazard, or warning condition, while directional arrow 304b visually indicates the approach direction of the detected object relative to the host vehicle. In this regard, directional arrow 304b indicates that the RCTA system has detected an object that is approaching from the driver side of the host vehicle. If the RCTA system instead (or additionally) detects an object approaching from the passenger side of the host vehicle, then an equivalent cross traffic warning symbol 308 will be rendered on the passenger side of rear display 302 (depicted in dashed lines in FIG. 3). If the RCTA system detects objects on both sides of the host vehicle, then two cross traffic warning symbols can be rendered on rear display 302.

It should be appreciated that the icons, graphical elements, shapes, and sizes used for the cross traffic warning symbols may vary to suit the preferences of the user and/or to suit the needs of the particular deployment. For example, a cross traffic warning symbol may include only one graphical icon, e.g., an arrow, a star, a depiction of a vehicle, or a warning triangle. In certain embodiments, such as that shown in FIG. 3, the cross traffic warning symbol includes an arrow pointing toward the driver side of the host vehicle when the sensor data indicates a potential cross traffic collision between the host vehicle and a driver-side detected object that is behind the host vehicle. Similarly, the cross traffic warning symbol may include an arrow pointing toward the passenger side of the host vehicle when the sensor data indicates a potential cross traffic collision between the host vehicle and a passenger-side detected object that is behind the host vehicle. In preferred embodiments, the cross traffic warning symbol itself is rendered on the left or right side of rear display 302 as needed to indicate the approaching direction of the detected cross traffic. For instance, the cross traffic warning symbol is preferably displayed on the driver side of rear display 302 when the sensor data indicates a potential cross traffic collision between the vehicle and a driver-side detected object behind the vehicle. On the other hand, the cross traffic warning symbol is preferably displayed on the passenger side of rear display 302 when the sensor data indicates a potential cross traffic collision between the vehicle and a passenger-side detected object behind the vehicle.

Rear vision display element 300 may be located in any desired position onboard the host vehicle (as described previously). In this regard, FIG. 4 is an elevation view of a portion of a host vehicle having deployed therein an exemplary embodiment of an RCTA system. FIG. 4 illustrates a number of possible locations that are suitable for a rear vision display element. For example, a rear vision display element could be located in a dashboard or console location 402, or in a visor location 404, or in an inside rear view mirror-inset location 405. In alternate embodiments, the RCTA system could deploy two rear vision display elements (driver side and passenger side). In this regard, rear vision display elements could be integrated into the side mirrors 406 of the host vehicle. In certain embodiments, rear vision display elements could be located in a windshield pillar position 408 of the host vehicle. Similarly, rear vision display elements could be located or integrated into the rear window pillars of the host vehicle to accommodate drivers who turn their heads when driving in reverse.

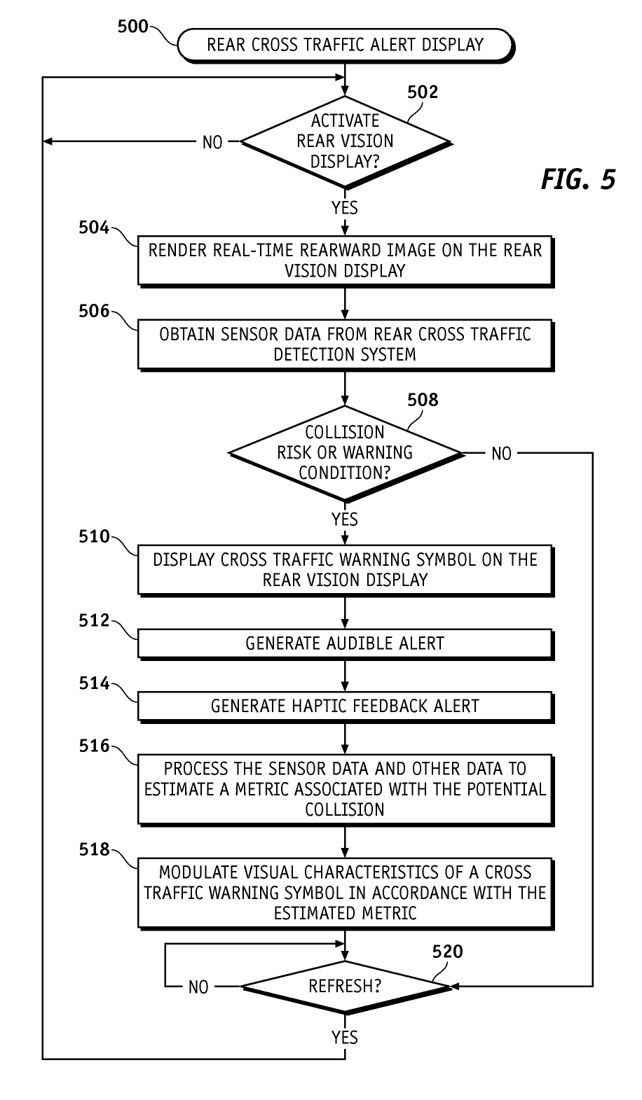

During operation of the host vehicle, the RCTA system can react and respond to the sensor data obtained from its rear cross traffic detection/sensing system and generate appropriate cross traffic display alerts as needed. In practice, the rear vision display having the features and elements described herein can be generated and dynamically updated and refreshed in real-time (or substantially real-time) during operation of the host vehicle. In this regard, FIG. 5 is a flow chart that illustrates an exemplary embodiment of a rear cross traffic alert display process 500, which can be performed by a suitably configured RCTA system. The various tasks performed in connection with process 500 may be performed by software, hardware, firmware, or any combination thereof. For illustrative purposes, the following description of process 500 may refer to elements mentioned above in connection with FIGS. 2-4. In practice, portions of process 500 may be performed by different elements of the described system, e.g., a sensor, a processor component, a display element, or the like. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein.

As described above, preferred embodiments of an RCTA system leverage the functionality of a rear vision display. Accordingly, this embodiment of process 500 determines whether to activate the rear vision display of the host vehicle (query task 502). For query task 502, the RCTA system could monitor a mode indicator, vehicle status data (such as gear status data 214 depicted in FIG. 2), or other onboard data that is indicative of the need to provide the rear vision display to the driver. For this example, the rear vision display is activated when the host vehicle is in reverse gear. In a practical deployment, the RCTA system would not activate the rear vision display. Instead, both systems (RCTA and rear vision) would activate together and, as explained above, both systems could utilize the same display element.

When the rear vision display is activated, process 500 will render a real-time rearward image on the rear vision display (task 504). This rearward image corresponds to a rearward view captured by the rear vision camera located at or near the rear of the host vehicle. In addition, process 500 obtains sensor data from the rear cross traffic detection/sensing system (task 506). The sensor data will be indicative of the presence or absence of an object (or objects) behind and to the side (or sides) of the host vehicle. In certain embodiments, the sensor data conveys or is otherwise indicative of the distance between the host vehicle and the detected object. The received sensor data can be processed and analyzed in an appropriate manner to determine whether or not the sensor data indicates a potential cross traffic collision (or other warning condition or state) between the host vehicle and a detected object (query task 508).

A practical implementation of an RCTA system could analyze and process the sensor data in any number of different ways to determine when a collision might be imminent. For example, query task 508 may trigger an alert whenever an object is detected by the rear cross traffic detection/sensing system. Alternatively, the RCTA system might be designed to process and analyze additional information and/or vehicle status data before triggering an alert. For example, the RCTA system may be suitably configured to determine and analyze any of the following information in connection with the decision made during query task 508: the speed of the approaching object; the speed of the host vehicle; an estimated time-to-collision between the host vehicle and the detected object; an estimated distance-to-collision between the host vehicle and the detected object; or the like. In other words, query task 508 need not automatically trigger a rear cross traffic alert based solely upon the detection of an object behind and on the side of the host vehicle. Rather, the RCTA system could be designed to predict whether or not an actual collision or hazard risk exists and respond accordingly.

If query task 508 detects a rear cross traffic collision risk, then process 500 can generate and display an appropriate cross traffic warning symbol on the rear vision display element of the host vehicle (task 5 10). As explained above, the cross traffic warning symbol includes one or more graphically rendered icons or elements that visually indicate the presence of the detected object. In preferred embodiments, the cross traffic warning symbol (or symbols) and the rear vision image are rendered together such that the cross traffic warning symbol is superimposed on the rear vision image. Moreover, as described above with reference to FIG. 3, the cross traffic warning symbol can be rendered with appropriate content and/or in an intuitive location on the display element such that it indicates the approach direction or position of the detected object, relative to the host vehicle.

An implementation of the RCTA system could utilize audible and/or haptic feedback in conjunction with the display of a rear cross traffic alert symbol. Accordingly, process 500 may perform an optional task 512 to generate an audible alert when the sensor data indicates a potential cross traffic collision. Additionally (or alternatively), process 500 may perform an optional task 514 to generate a haptic feedback alert when the sensor data indicates a potential cross traffic collision.

Although not required, the RCTA system could be designed to vary one or more visually distinguishable characteristics of the cross traffic warning symbol in a manner that conveys or indicates useful information to the driver. For example, a cross traffic warning symbol can be rendered using visually distinguishable characteristics associated with: a time-to-collision; a distance-to-collision; the potential collision severity; the speed of the approaching vehicle; or the like. The visually distinguishable characteristics can be specified such that the user can quickly and easily interpret the meaning of the displayed cross traffic warning symbol. In practice, the different visually distinguishable characteristics may correspond to any of the following characteristics, individually or in any combination thereof: different colors; different brightness; different transparency levels; different translucency levels; different line patterns; different line thickness; different shapes; different sizes; different display locations; different flicker patterns; different focus levels; different sharpness levels; duty cycle of displayed features; frequency of displayed features; duration of display; different clarity levels; etc.

The control of variable display characteristics may be influenced or dictated by the sensor data provided by the rear cross traffic detection/sensing system and/or other data available to the RCTA system. In this regard, process 500 may process the sensor data (and/or other data) to estimate, calculate, or determine at least one metric that is associated with the detected object, the approaching traffic, the potential collision, or the like (task 516). For example, the metric could be related to a time-to-collision between the vehicle and the detected object, such that task 516 obtains an estimated time. As another example, the metric could be related to a distance-to-collision between the vehicle and the detected object, such that task 516 obtains an estimated distance. As yet another example, the metric could be related to a potential collision severity between the vehicle and the detected object, such that task 516 obtains an estimated severity. These examples are not exhaustive, and the RCTA system could process and handle other metrics as appropriate to the particular embodiment.

This embodiment of process 500 continues by modulating, varying, adjusting, changing, or otherwise controlling at least one visually distinguishable characteristic of the rear cross traffic warning symbol in accordance with the estimated metric (task 518). The manner in which the displayed feature (or features) is modulated can vary from one embodiment to another. For example, the warning symbol could be displayed in a flashing manner when the approaching traffic is relatively far away from the host vehicle, and in a solid or continuous manner when the approaching traffic is relatively close to the host vehicle. As another example, the warning symbol could be rendered in a first color (e.g., yellow) if the estimated time-to-collision is relatively long, and in a second color (e.g., red) if the estimated time-to-collision is relatively short. Of course, any visually distinguishable characteristic of the warning symbol could be gradually or continuously varied to indicate an escalating (or diminishing) threat or warning level.

If it is time to refresh the display (query task 520), then process 500 may lead back to query task 502 to obtain the most current data and update the rear vision display. If not, then the current state of the rear vision display is maintained. The relatively high refresh rate of process 500 results in a relatively seamless and immediate updating of the rear vision display and rear cross traffic alert symbols (if needed).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for displaying rear cross traffic alert information on a rear vision display element of a vehicle, the method comprising:
obtaining sensor data from a rear cross traffic detection system;
determining when the sensor data indicates a potential cross traffic collision between the vehicle and a detected object;
in response to the determining step, displaying a cross traffic warning symbol on the rear vision display element, the cross traffic warning symbol visually indicating presence of the detected object.

2. The method of claim 1, the cross traffic warning symbol visually indicating an approach direction of the detected object relative to the vehicle.

3. The method of claim 2, wherein the displaying step displays an arrow pointing toward the driver side of the vehicle when the sensor data indicates a potential cross traffic collision between the vehicle and a driver-side detected object behind the vehicle.

4. The method of claim 2, wherein the displaying step displays an arrow pointing toward the passenger side of the vehicle when the sensor data indicates a potential cross traffic collision between the vehicle and a passenger-side detected object behind the vehicle.

5. The method of claim 2, wherein the displaying step displays the cross traffic warning symbol on the driver side of the rear vision display element when the sensor data indicates a potential cross traffic collision between the vehicle and a driver-side detected object behind the vehicle.

6. The method of claim 2, wherein the displaying step displays the cross traffic warning symbol on the passenger side of the rear vision display element when the sensor data indicates a potential cross traffic collision between the vehicle and a passenger-side detected object behind the vehicle.

7. The method of claim 1, further comprising rendering on the rear vision display element a real-time rearward image corresponding to a rearward view from the vehicle, wherein the displaying step comprises superimposing the cross traffic warning symbol on the real-time rearward image.

8. The method of claim 1, further comprising:
processing at least the sensor data to estimate a time-to-collision between the vehicle and the detected object, resulting in an estimated time; and
modulating a visually distinguishable characteristic of the cross traffic warning symbol in accordance with the estimated time.

9. The method of claim 1, further comprising:
processing at least the sensor data to estimate a distance-to-collision between the vehicle and the detected object, resulting in an estimated distance; and
modulating a visually distinguishable characteristic of the cross traffic warning symbol in accordance with the estimated distance.

10. The method of claim 1, further comprising:
processing at least the sensor data to estimate a potential collision severity between the vehicle and the detected object, resulting in an estimated severity; and
modulating a visually distinguishable characteristic of the cross traffic warning symbol in accordance with the estimated severity.

11. The method of claim 1, further comprising the step of generating an audible alert when the sensor data indicates a potential cross traffic collision between the vehicle and the detected object.

12. The method of claim 1, further comprising the step of generating a haptic feedback alert when the sensor data indicates a potential cross traffic collision between the vehicle and the detected object.

13. A rear cross traffic alert system for a vehicle, the system comprising:
a sensing subsystem configured to monitor for cross traffic behind the vehicle;
a processor architecture configured to receive sensor data from the sensing subsystem and, when the sensor data indicates a warning condition caused by an object detected by the sensing subsystem, generate image rendering display commands associated with a cross traffic warning symbol; and
a rear vision display element configured to receive the image rendering display commands and, in response thereto, render the cross traffic warning symbol in a manner that visually indicates presence of the object.

14. The rear cross traffic alert system of claim 13, wherein the cross traffic warning symbol visually indicates an approach direction of the object relative to the vehicle.

15. The rear cross traffic alert system of claim 13, further comprising a rear vision camera configured to capture a real-time rearward image corresponding to a rearward view from the vehicle, wherein the processor architecture is configured to generate the image rendering commands such that the image rendering commands are associated with the real-time rearward image, and wherein the rear vision display element is configured to render the cross traffic warning symbol such that it is superimposed on the real-time rearward image.

16. The rear cross traffic alert system of claim 13, wherein the rear vision display element is integrated into a rearview mirror of the vehicle, a side mirror of the vehicle, a video game unit of the vehicle, an audio/visual entertainment unit of the vehicle, a head-up display of the vehicle, a navigation unit of the vehicle, a dashboard display unit of the vehicle, a visor of the vehicle, or a passenger cabin pillar of the vehicle.

17. The rear cross traffic alert system of claim 13, further comprising an audio element configured to generate an audible alert when the sensor data indicates the warning condition.

18. The rear cross traffic alert system of claim 13, further comprising a haptic feedback element configured to generate a haptic feedback alert when the sensor data indicates the warning condition.

19. A rear vision display element for a vehicle, the rear vision display element having rendered thereon a rear display comprising:
a real-time rearward image corresponding to a rearward view from the vehicle; and
a cross traffic warning symbol superimposed on the real-time rearward image, the cross traffic warning symbol visually indicating presence of an object behind and to the side of the vehicle.

20. The rear vision display element of claim 19, wherein the cross traffic warning symbol visually indicates an approach direction of the object relative to the vehicle.
